(19) United States
(12) Patent Application Publication
(10) Pub. No.: US 2006/0073363 A1
(43) Pub. Date: Apr. 6, 2006

(54) Fuel cell system, and failure diagnosing apparatus of the same

(75) Inventors: Ikuhiro Taniguchi, Zushi-shi (JP); Keisuke Suzuki, Fujisawa-shi (JP)

Correspondence Address: FOLEY AND LARDNER LLP;SUITE 500, 3000 K STREET NW, WASHINGTON, DC, 20007, US

(73) Assignee: NISSAN MOTOR CO., LTD.

(21) Appl. No.: 11/235,104

(22) Filed: Sep. 27, 2005

(30) Foreign Application Priority Data
Sep. 28, 2004 (JP) 2004-281418

(51) Int. Cl. H01M 8/00; H01M 10/48

(52) U.S. Cl. 429/12; 429/13; 429/90

(57) ABSTRACT

A fuel cell system includes: 1) a fuel gas circulating system; 2) a first pressure sensor for sensing a fuel cell inlet sensed pressure; 3) a second pressure sensor for sensing a fuel gas circulating system inlet sensed pressure; 4) a fuel gas circulating system inlet target pressure operator for operating a fuel gas circulating system inlet target pressure, based on the following: i) the fuel cell inlet sensed pressure sensed with the first pressure sensor, and ii) a fuel cell inlet target pressure; and 5) a fuel gas circulating system inlet pressure controller for controlling the pressure of the fuel gas supplied to the fuel cell, by so regulating the pressure regulator valve that the fuel gas circulating system inlet sensed pressure sensed with the second pressure sensor becomes the fuel gas circulating system inlet target pressure operated by the fuel gas circulating system inlet target pressure operator.

### BACKGROUND OF THE INVENTION

1. Field of the Invention

The present invention relates to a fuel cell system provided with a circulating system for circulating a fuel gas, and relates to a failure diagnosing apparatus of the fuel cell system diagnosing an open failure of a purge valve purging the fuel gas out of the fuel cell system.

2. Description of the Related Art

Japanese Patent Unexamined Publication No. JP2003092125 discloses a fuel cell control device.

In the fuel cell control device provided with a hydrogen circulating system according to JP2003092125, a pressure sensor sensing pressure of hydrogen is disposed only at a fuel cell stack's inlet.

### SUMMARY OF THE INVENTION

It is an object of the present invention to provide a fuel cell system improving controllability of a pressure of a fuel gas supplied to a fuel cell.

It is another object of the present invention to provide a failure diagnosing apparatus of the fuel cell system capable of diagnosing an open failure of a purge valve which selectively exhausts the fuel gas of the fuel cell system.

According to a first aspect of the present invention, there is provided a fuel cell system, comprising: 1) a fuel gas circulating system, including: a fuel cell for generating an electric power by a chemical reaction of a fuel gas with an oxidant gas, the fuel gas circulating system being supplied with the fuel gas having a pressure regulated by way of a pressure regulator valve connected to the fuel gas circulating system, and the fuel gas circulating system returning to the fuel cell's inlet the fuel gas which is unused and exhausted from the fuel cell, to thereby circulate the fuel gas; 2) a first pressure sensor for sensing a fuel cell inlet sensed pressure; 3) a second pressure sensor for sensing a fuel gas circulating system inlet sensed pressure; 4) a fuel gas circulating system inlet target pressure operator for operating a fuel gas circulating system inlet target pressure, based on the following: i) the fuel cell inlet sensed pressure sensed with the first pressure sensor, and ii) a fuel cell inlet target pressure; and 5) a fuel gas circulating system inlet pressure controller for controlling the pressure of the fuel gas supplied to the fuel cell, by so regulating the pressure regulator valve that the fuel gas circulating system inlet sensed pressure sensed with the second pressure sensor becomes the fuel gas circulating system inlet target pressure operated by the fuel gas circulating system inlet target pressure operator.

The fuel gas circulating system inlet target pressure operator according to the first aspect includes: 1) a feedforward compensator for operating a first fuel gas circulating system inlet target pressure, based on a target takeout current from the fuel cell, and 2) a feedback compensator for operating a second fuel gas circulating system inlet target pressure, based on the following: the fuel cell inlet sensed pressure sensed with the first pressure sensor, and the fuel cell inlet target pressure. The fuel gas circulating system inlet target pressure operator operates the fuel gas circulating system inlet target pressure, based on the following: i) the first fuel gas circulating system inlet target pressure operated by the feedforward compensator, and ii) the second fuel gas circulating system inlet target pressure operated by the feedback compensator.

According to a second aspect of the present invention, there is provided a method of controlling a pressure of a fuel gas supplied to a fuel cell of a fuel cell system which includes a fuel gas circulating system, including the fuel cell for generating an electric power by a chemical reaction of a fuel gas with an oxidant gas, the fuel gas circulating system being supplied with the fuel gas having the pressure regulated by way of a pressure regulator valve connected to the fuel gas circulating system, and the fuel gas circulating system returning to the fuel cell's inlet the fuel gas which is unused and exhausted from the fuel cell, to thereby circulate the fuel gas, the method comprising: 1) sensing a fuel cell inlet sensed pressure; 2) sensing a fuel gas circulating system inlet sensed pressure; 3) operating a fuel gas circulating system inlet target pressure, based on the following: i) the fuel cell inlet sensed pressure sensed with the first pressure sensor, and ii) a fuel cell inlet target pressure; and 4) controlling the pressure of the fuel gas supplied to the fuel cell, by so regulating the pressure regulator valve that the fuel gas circulating system inlet sensed pressure sensed by the sensing of the fuel gas circulating system inlet sensed pressure becomes the fuel gas circulating system inlet target pressure operated by the operating of the fuel gas circulating system inlet target pressure.

According to a third aspect of the present invention, there is provided a fuel cell system, comprising: 1) a fuel gas circulating means, including: an electric power generating means for generating an electric power by a chemical reaction of a fuel gas with an oxidant gas, the fuel gas circulating means being supplied with the fuel gas having a pressure regulated by way of a pressure regulator valve connected to the fuel gas circulating means, and the fuel gas circulating means returning to the electric power generating mean's inlet the fuel gas which is unused and exhausted from the electric power generating means, to thereby circulate the fuel gas; 2) a first pressure sensing means for sensing a fuel cell inlet sensed pressure; 3) a second pressure sensing means for sensing a fuel gas circulating system inlet sensed pressure; 4) a fuel gas circulating system inlet target pressure operating means for operating a fuel gas circulating system inlet target pressure, based on the following: i) the fuel cell inlet sensed pressure sensed with the first pressure sensing means, and ii) a fuel cell inlet target pressure; and 5) a fuel gas circulating system inlet pressure controlling means for controlling the pressure of the fuel gas supplied to the electric power generating means, by so regulating the pressure regulator valve that the fuel gas circulating system inlet sensed pressure sensed with the second pressure sensing means becomes the fuel gas circulating system inlet target pressure operated by the fuel gas circulating system inlet target pressure operating means.

According to a fourth aspect of the present invention, there is provided a failure diagnosing apparatus of the fuel cell system that is described in the first aspect, comprising: 1) a purge valve selectively purging the fuel gas exhausted from the fuel cell; and 2) a failure diagnosing unit diagnosing an open failure of the purge valve based on a variation amount of the second fuel gas circulating system inlet target pressure operated by the feedback compensator of the fuel gas circulating system inlet target pressure operator.

According to a fifth aspect of the present invention, there is provided a failure diagnosing apparatus of the fuel cell system that is described in the first aspect, comprising: 1) a purge valve selectively purging the fuel gas exhausted from the fuel cell; and 2) a failure diagnosing unit diagnosing an open failure of the purge valve based on a variation amount of the fuel gas circulating system inlet sensed pressure sensed with the second pressure sensor.

The other object(s) and feature(s) of the present invention will become understood from the following description with reference to the accompanying drawings.

### BRIEF DESCRIPTION OF THE DRAWINGS

FIG. 1 shows a structure of a fuel cell system, according to a first embodiment of the present invention.

FIG. 2 shows a structure of a hydrogen circulating system inlet pressure controller in FIG. 1.

FIG. 3A is control block diagram showing a structure of a hydrogen circulating system inlet target pressure operator in FIG. 1, while FIG. 3B shows an FF (feedforward) map.

FIG. 4 shows a structure of a failure diagnosing apparatus of the fuel cell system, according to a second embodiment of the present invention.

FIG. 5A shows pressure signal response when a purge valve is in an ordinary state, while FIG. 5B shows pressure signal response when the purge valve is in open-failure, according to the second embodiment of the present invention.

FIG. 6 shows the structure of the failure diagnosing apparatus of the fuel cell system, according to a third embodiment of the present invention.

FIG. 7A shows a part of the structure of the failure diagnosing apparatus of the fuel cell system, while FIG. 7B shows operations of the failure diagnosing apparatus, according to a fourth embodiment of the present invention.

FIG. 8A shows pressure signal response when the purge valve is in the ordinary state, while FIG. 8B shows pressure signal response when the purge valve is in the open-failure, according to the fourth embodiment of the present invention.

### DESCRIPTION OF THE PREFERRED EMBODIMENTS

In the following, various embodiments of the present invention will be described in detail with reference to the accompanying drawings.

### First Embodiment

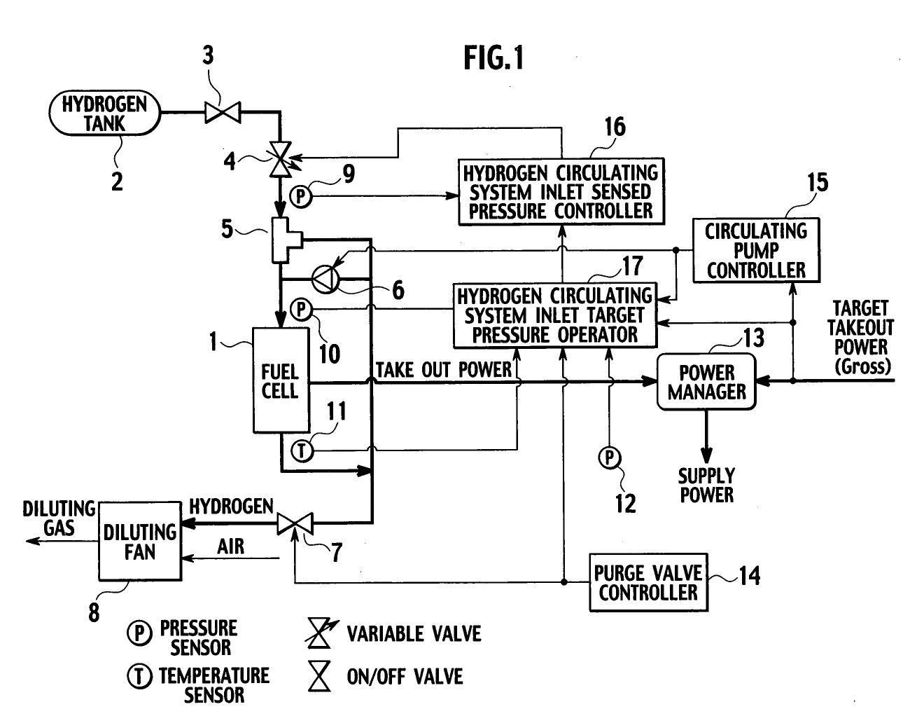

FIG. 1 shows a structure of a fuel cell system, according to a first embodiment of the present invention. The fuel cell system shown in FIG. 1 according to the first embodiment is provided with a fuel cell 1 having a hydrogen circulating system which reuses unused hydrogen in an electric power generation. The fuel cell 1 has a structure in which hydrogen (fuel gas) is supplied to an anode and air (oxidant gas) is supplied to a cathode, promoting the electrode reaction shown below, thus generating an electric power. An air supply system supplying the air to the fuel cell 1 is omitted from FIG. 1.
Anode (hydrogen electrode): H₂→2H⁺+2e⁻
Cathode (oxygen electrode): 2H⁺+2e⁻+(½)O₂→H₂O (Chemical formula 1)

The hydrogen is supplied to the anode of the fuel cell 1 from a hydrogen tank 2 by way of a decompressing valve 3 and the pressure regulator valve 4. With the decompressing valve 3, the high pressure hydrogen supplied from the hydrogen tank 2 is to be mechanically decompressed to a predetermined pressure. Then, with the pressure regulator valve 4, the thus decompressed hydrogen is to be controlled to a desired hydrogen pressure for the fuel cell 1's inlet.

An ejector 5 structuring a hydrogen supply system is disposed on a downstream side of the pressure regulator valve 4. To the fuel cell 1's hydrogen inlet, the ejector 5 returns the unused hydrogen which is exhausted from the fuel cell 1 without being consumed at the anode, thus recirculating the hydrogen. A circulating pump 6 structuring the hydrogen supply system is arranged in parallel with the ejector 5. The circulating pump 6 is to be operated in a generation area where the ejector 5 does not function, returning the hydrogen exhausted from the fuel cell 1 to the fuel cell 1's hydrogen inlet bypassing the ejector 5.

On a downstream side of the fuel cell 1's outlet, there is provided a purge valve 7 exhausting the hydrogen exhausted from the fuel cell 1 without allowing the circulation of the hydrogen. A nitrogen transmitting from the cathode to the anode of the fuel cell 1 by way of an electrolyte membrane may make heavier the gas in the hydrogen system, thus slowing down hydrogen circulating function. Opening the purge valve 7 in a preset purge period may work for exhausting the nitrogen stored in the hydrogen system, thus securing the hydrogen circulating function. In addition, opening of the purge valve 7 is also for blowing off water content stored in the hydrogen system's flow channel, recovering cell voltage. There is provided a diluting fan 8 on a downstream side of the purge valve 7 described above. Taking in air from outside, the diluting fan 8 dilutes a hydrogen mix gas (purged by the purge valve 7) to less than combustible density, to thereafter exhaust the thus diluted hydrogen mix gas from the hydrogen system of the fuel cell 1. Increasing an amount of the thus taken-in air can increase diluting capability of the diluting fan 8.

In the hydrogen system's flow channel between the pressure regulator valve 4 and the ejector 5, there is provided a first pressure sensor 9 (P) sensing a pressure of the hydrogen introduced into the ejector 5, which pressure is hereinafter referred to as a hydrogen circulating system inlet sensed pressure Ps9. In the hydrogen system's flow channel between a connecting point (connecting the ejector 5 with the circulating pump 6) and the fuel cell 1's hydrogen inlet, there is provided a second pressure sensor 10 (P) sensing a pressure of the hydrogen introduced into the fuel cell 1. At the fuel cell 1's outlet, there is provided a temperature sensor 11 (T) sensing temperature of the hydrogen exhausted from the fuel cell 1. In addition, the fuel cell system is provided with an atmospheric pressure sensor 12 (P) sensing atmospheric pressure around the fuel cell system.

A power manager 13 may take out the electric power from the fuel cell 1, supplying the thus taken-out electric power, for example, to a motor (not shown, in other words, a load) driving a vehicle.

In addition, the fuel cell system is provided with a control unit. The control unit functions as a control center which controls operations of the fuel cell system, and can be realized, for example, by a microcomputer provided with sources such as CPU (not shown), memory unit (not shown), and input output unit (not shown) which are necessary for a computer controlling various operations based on program. The control unit reads in signals from various sensors of the fuel cell system, including the second pressure sensor 9, the first pressure sensor 10, the atmospheric pressure sensor 12 and the temperature sensor 11. Then, based on the thus read-in signals and a control logic (program) which is internally retained in advance, the control unit sends instructions to each structural element of the fuel cell system including the pressure regulator valve 4 and the purge valve 7. Thereby, the control unit administratively controls operations which are necessary for operating and stopping the fuel cell system, where the above operations include pressure control of the hydrogen supplied to the fuel cell 1, to be described afterward. The control unit is provided with a purge valve controller 14, a circulating pump controller 15, a hydrogen circulating system inlet pressure controller 16 and a hydrogen circulating system inlet target pressure operator 17.

The purge valve controller 14 gives an open-close signal to the purge valve 7, thereby controlling opening-closing operations of the purge valve 7 in the preset purge period which is preset, for example, by a timer.

The circulating pump controller 15 controls operations of the circulating pump 6 based on a target takeout power (or a target takeout current It) from the fuel cell 1. When the target takeout power from the fuel cell 1 is small in such a state as idling of vehicle, there may occur an area where the consumed hydrogen amount in the fuel cell 1 is small and therefore the ejector 5 is unable to circulate the hydrogen. Particularly in the above state, the circulating pump controller 15 operates the circulating pump 6.

For converting the hydrogen circulating system inlet sensed pressure Ps9 sensed with the second pressure sensor 9 into a hydrogen circulating system inlet target pressure operated by the hydrogen circulating system inlet target pressure operator 17, the hydrogen circulating system inlet pressure controller 16 controls at least one of i) an opening degree of the pressure regulator valve 4 and ii) a drive current of an actuator (not shown) driving the pressure regulator valve 4.

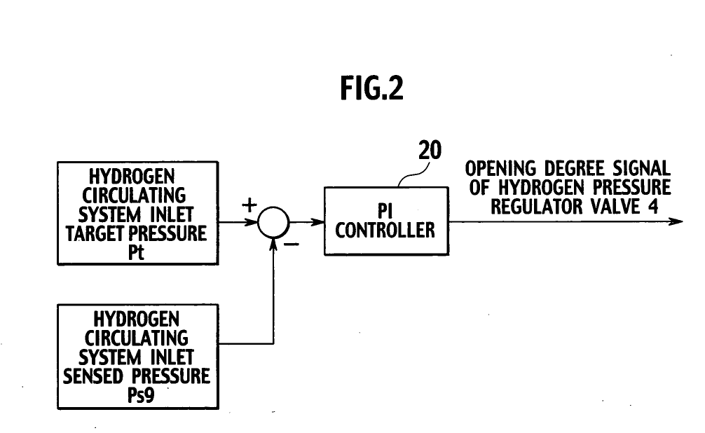

The hydrogen circulating system inlet pressure controller 16 has a structure as shown by a control block diagram in FIG. 2. In FIG. 2, the hydrogen circulating system inlet pressure controller 16 generates control signals according to a known PI control. Inputting into a PI controller 20 a pressure value which is obtained by subtracting from the hydrogen circulating system inlet target pressure the hydrogen circulating system inlet sensed pressure Ps9 sensed with the second pressure sensor 9, the hydrogen circulating system inlet pressure controller 16 generates an opening degree signal controlling the opening degree of the pressure regulator valve 4, which signal is to be given to the pressure regulator valve 4.

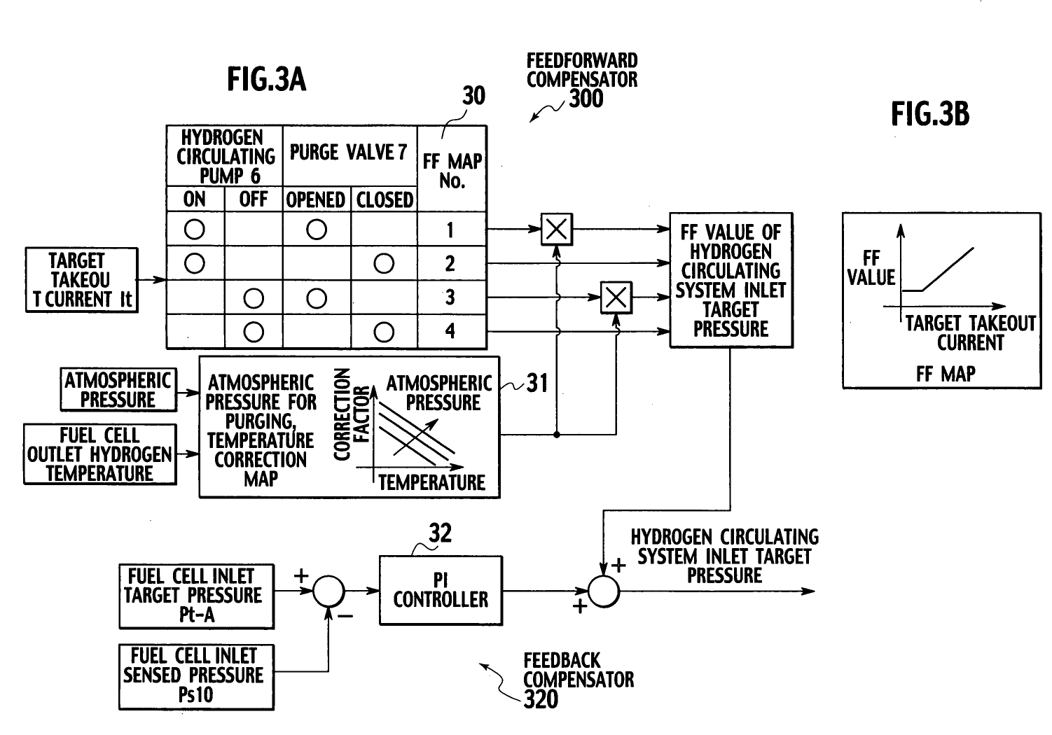

Back to FIG. 1, the hydrogen circulating system inlet target pressure operator 17 operates the hydrogen circulating system inlet target pressure based on a fuel cell inlet sensed pressure Ps10 sensed with the first pressure sensor 10 and on a fuel cell inlet target pressure Pt-A. The hydrogen circulating system inlet target pressure operator 17 has a structure as shown by a control block diagram in FIG. 3A.

In FIG. 3A, the hydrogen circulating system inlet target pressure operator 17 includes a feedforward compensator 300 and a feedback compensator 320. The feedforward compensator 300 operates a first hydrogen circulating system inlet target pressure Pt1, based on the target takeout current It from the fuel cell 1, ON/OFF of the circulating pump 6, opening-closing state of the purge valve 7, the atmospheric pressure, the hydrogen temperature of the fuel cell 1's outlet. The feedforward compensator 300 is provided with a map 30 which outputs a feedforward value (FF value) of the first hydrogen circulating system inlet target pressure Pt1 according to the target takeout current It from the fuel cell 1. As shown in FIG. 3A, the map 30 prepares four types of FF values (No. 1 to No. 4) corresponding to combinations of ON/OFF of the circulating pump 6 with opening-closing state of the purge valve 7. Thereby, the four types of FF values can be selected according to states of the circulating pump 6 and the purge valve 7.

In addition, the feedforward compensator 300 is provided with a correcting map 31 determining a correction factor for correcting the FF value when the purge valve 7 is open. The correction factor is prepared in advance for the correcting map 31, where the correction factor corrects the FF value based on the atmospheric pressure sensed with the atmospheric pressure sensor 12 and on the hydrogen temperature of the fuel cell 1's outlet sensed with the temperature sensor 11.

On the other hand, based on the fuel cell inlet target pressure Pt-A and on the fuel cell inlet sensed pressure Ps10 sensed with the first pressure sensor 10, the feedback compensator 320 allows a PI controller 32 (using a method of the known PI control) to operate a second hydrogen circulating system inlet target pressure Pt2 correcting the first hydrogen circulating system inlet target pressure Pt1. Then, using the second hydrogen circulating system inlet target pressure Pt2 obtained by the above operation, the feedback compensator 320 allows the PI controller 32 to correct the first hydrogen circulating system inlet target pressure Pt1 operated by the feedforward compensator 300.

A takeout current I from the fuel cell 1, when increased, may increase the consumed hydrogen amount of the fuel cell 1, thereby increasing hydrogen supply flowrate. The thus increased hydrogen supply flowrate may increase pressure drop of the ejector 5, thereby increasing a hydrogen circulating system inlet pressure which is necessary for keeping the fuel cell inlet pressure at the fuel cell inlet target pressure Pt-A. As shown in FIG. 3B, the hydrogen circulating system inlet target pressure operator 17 is so set that the target takeout current It, when increased, can increase the FF value of the first hydrogen circulating system inlet target pressure Pt1 of the map 30 of the feedforward compensator 30.

The pressure drop of the ejector 5 is different between i) when the circulating pump 6 is operated in the generation area where the ejector 5 is not functioning in a low load state during the electric power generation and ii) when the circulating pump 6 is not operated in the generation area where the ejector 5 is functioning during the electric power generation. Therefore, selecting the FF value of the first hydrogen circulating system inlet target pressure Pt1 is also to be according to an ON/OFF state of the circulating pump 6. In addition, for the fuel cell system having two or more ejectors 5, selecting the FF value of the first hydrogen circulating system inlet target pressure Pt1 may be according to an operation state of each of the ejectors 5.

In addition, the purge valve 7 when opened may correct output value of the map 30, according to the atmospheric pressure and to the hydrogen temperature of the fuel cell 1's outlet. The atmospheric pressure, when decreased at a highland, may increase purge exhaust flowrate of the hydrogen mix gas exhausted by way of the purge valve 7. In addition, decrease in temperature of the hydrogen exhausted from the fuel cell 1 may decrease partial pressure of vapor of the hydrogen circulating system, thereby increasing hydrogen content. The hydrogen being lighter than the vapor may increase the purge exhaust flowrate.

The thus increased purge exhaust flowrate may decrease the hydrogen inlet pressure of the fuel cell 1. Therefore, for keeping the fuel cell inlet pressure at the fuel cell inlet target pressure Pt-A, the hydrogen circulating system inlet pressure is to be increased. Then, the correcting map 31 so correcting that the increased atmospheric pressure in combination with the decreased hydrogen temperature can increase the FF value of the first hydrogen circulating system inlet target pressure Pt1 of the map 30 of the feedforward compensator 300 can implement such a control that the purge valve 7, when opened, does not decrease the fuel cell inlet pressure. In addition, the hydrogen temperature sensed with the temperature sensor 11 may be replaced with a hydrogen temperature which is estimated based on a pinch temperature of coolant temperature measured with a coolant temperature sensor 72. Specially hereinabove, the coolant temperature sensor 72 senses the temperature of a coolant which removes a heat caused in the electric power generation of fuel cell 1.

The above description according to the first embodiment can be summarized below.

The fuel cell system provided with the hydrogen circulating system returns the unused hydrogen (exhausted from the fuel cell 1) to the fuel cell 1's hydrogen inlet by way of the ejector 5, and adopts the following double-loop control structure, thereby controlling the pressure of the hydrogen supplied to the fuel cell 1:

<Double-Loop Control Structure>

(1) the hydrogen circulating system inlet target pressure operator 17 operating the hydrogen circulating system inlet target pressure, based on:

the fuel cell inlet sensed pressure Ps10 sensed with the first pressure sensor 10, and

the fuel cell inlet target pressure Pt-A; and

(2) the hydrogen circulating system inlet pressure controller 16 controlling at least one of i) the opening degree of the pressure regulator valve 4 and ii) the drive current of the actuator (not shown) driving the pressure regulator valve 4, based on:

the hydrogen circulating system inlet target pressure operated by the hydrogen circulating system inlet target pressure operator 17, and

the hydrogen circulating system inlet sensed pressure Ps9 sensed with the second pressure sensor 9.

The pressure regulator valve 4, when directly controlling the fuel cell inlet pressure to the fuel cell inlet target pressure Pt-A, may cause the pressure drop to the ejector 5 and circulating pump 6 in the circulating operation of the hydrogen, where the pressure drop may be varied with hydrogen flowrate. The thus varied pressure drop may cause an inability to increase control gain, making it difficult to satisfy both responsiveness and stability of the hydrogen pressure control.

Contrary to the above, the fuel cell system according to the first embodiment having the double-loop structure of the pressure control system of the hydrogen supplied to the fuel cell 1 enables the following operations respectively by the above (1) and (2):

By (1): operating the hydrogen pressure in view of the pressure drop of the ejector 5 and circulating pump 6 which are disposed between the pressure regulator valve 4 and the fuel cell 1, and

By (2): increasing the control gain without being influenced by the pressure drop of the ejector 5 and circulating pump 6.

Thereby, the responsiveness and stability of the hydrogen pressure control can be improved.

The hydrogen circulating system inlet target pressure operator 17 is provided with: i) the feedforward compensator 300 operating the first hydrogen circulating system inlet target pressure Pt1, based on the target takeout current It from the fuel cell 1, and ii) the feedback compensator 320 operating the second hydrogen circulating system inlet target pressure Pt2, based on the fuel cell inlet sensed pressure Ps10 and on the fuel cell inlet target pressure Pt-A. With the above structure, the target takeout current It from the fuel cell 1, when increased, may increase the first hydrogen circulating system inlet target pressure Pt1 outputted by the feedforward compensator 300, keeping the fuel cell inlet pressure at the fuel cell inlet target pressure Pt-A. Therefore, the takeout current I from the fuel cell 1, even when varied, can keep the fuel cell inlet pressure at the fuel cell inlet target pressure Pt-A.

The feedforward compensator 300 of the hydrogen circulating system inlet target pressure operator 17 is so structured as to operate the first hydrogen circulating system inlet target pressure Pt1 based on the target takeout current It from the fuel cell 1, the operation states of the ejector 5 and circulating pump 6 of the hydrogen circulating system, the opening-closing state of the purge valve 7, the atmospheric pressure, and hydrogen temperature of the fuel cell 1's outlet.

The pressure drop of the hydrogen supply flow channel from the pressure regulator valve 4 to the fuel cell 1 may vary according to the operation state of the hydrogen circulating system, thereby varying the fuel cell inlet pressure relative to the hydrogen circulating system inlet pressure. Therefore, the first hydrogen circulating system inlet target pressure Pt1 outputted by the feedforward compensator 300 is varied according to the operation state of the hydrogen circulating system, thereby keeping the fuel cell inlet pressure at the fuel cell inlet target pressure Pt-A even when at least one of the ejector 5 and the circulating pump 6 is making the ON/OFF operation.

The purge valve 7, when opened, decreases the fuel cell inlet pressure. Therefore, the hydrogen circulating system inlet pressure is to be increased. Therefore, allowing the feedforward compensator 300 to operate the first hydrogen circulating system inlet target pressure Pt1 based on the opening-closing state of the purge valve 7 can keep the fuel cell inlet pressure at the fuel cell inlet target pressure Pt-A even when the purge valve 7 is opening-closing.

The atmospheric pressure, when decreased, may increase the purge exhaust flowrate purged by way of the purge valve 7. Therefore, allowing the feedforward compensator 300 to operate the first hydrogen circulating system inlet target pressure Pt1 according to the atmospheric pressure can keep the fuel cell inlet pressure at the fuel cell inlet target pressure Pt-A even when the fuel cell system is operated at the highland.

The temperature of the hydrogen exhausted from the fuel cell 1, when varied, may vary the vapor content of the hydrogen circulating system, thereby varying the purge exhaust flowrate. Therefore, allowing the feedforward compensator 300 to operate the first hydrogen circulating system inlet target pressure Pt1 based on the hydrogen temperature can keep the fuel cell inlet pressure at the fuel cell inlet target pressure Pt-A from low hydrogen temperature to high hydrogen temperature. In addition, replacing the hydrogen temperature with the pinch temperature of the coolant temperature measured with the coolant temperature sensor 72 can delete the temperature sensor 11 measuring the hydrogen temperature.

### Second Embodiment

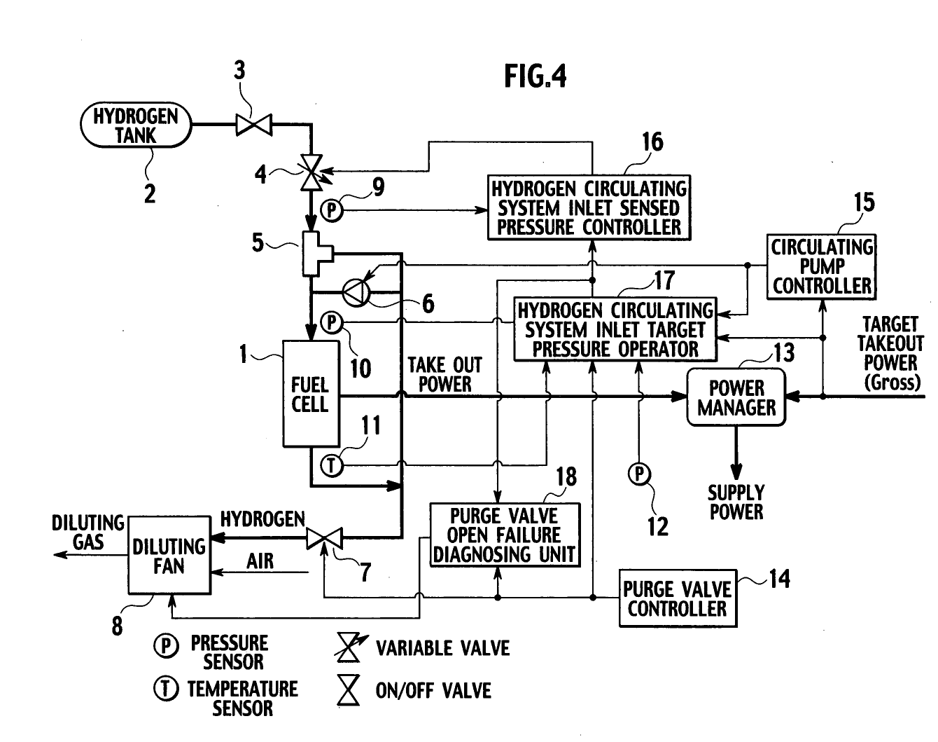

FIG. 4 shows a structure of a failure diagnosing apparatus of the fuel cell system, according to a second embodiment of the present invention. In FIG. 4, the second embodiment is characterized in that, in addition to the structure of the fuel cell system shown in FIG. 1 according to the first embodiment, the control unit is provided with a purge valve open failure diagnosing unit 18 for diagnosing open failure of the purge valve 7. Other operations (including control of the hydrogen pressure) according to the second embodiment are like those according to the first embodiment.

In FIG. 4, the purge valve open failure diagnosing unit 18 diagnoses the open failure of the purge valve 7, based on: i) an open-close signal given from the purge valve controller 14 to the purge valve 7 for instructing the opening-closing state of the purge valve 7, and ii) the hydrogen circulating system inlet target pressure operated by the hydrogen circulating system inlet target pressure operator 17.

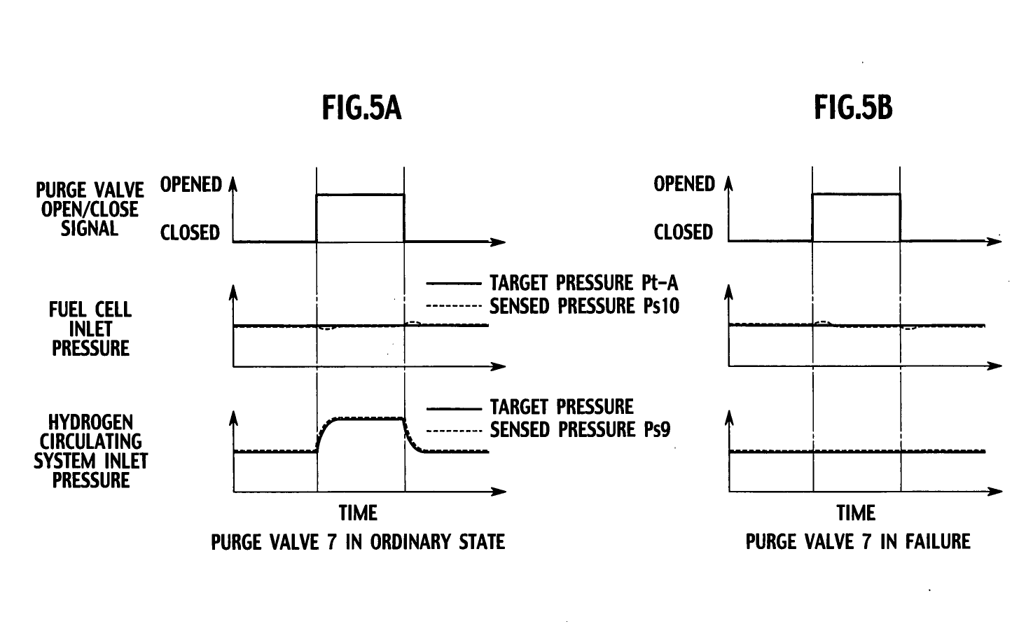

FIG. 5A shows pressure signal response when the purge valve 7 is in an ordinary state, while FIG. 5B shows pressure signal response when the purge valve 7 is in the open-failure. In FIG. 5A, with the purge valve 7 opened in the ordinary state, the hydrogen circulating system inlet pressure is increased for keeping the fuel cell inlet pressure at the fuel cell inlet target pressure Pt-A; while with the purge valve 7 closed in the ordinary state, the hydrogen circulating system inlet pressure is decreased. On the other hand, with the purge valve 7 in the open failure, even giving to the purge valve 7 the open signal for opening instruction fails to vary the hydrogen circulating system inlet pressure. Herein, for preventing erroneous diagnosis of the open failure; the FF value which corresponds to the opening-closing state of the purge valve 7 and is operated by the hydrogen circulating system inlet target pressure operator 17 is to be necessarily made constant. In addition, the FF value is to be necessarily set constant in a low area of the takeout current I from the fuel cell 1 as long as accuracy of regulating the hydrogen pressure is not influenced.

Based on the characteristics of the hydrogen circulating system inlet pressure, the purge valve open failure diagnosing unit 18 compares i) the hydrogen circulating system inlet target pressure when the purge valve 7 is opened ii) with the hydrogen circulating system inlet target pressure when the purge valve 7 is closed. With a difference between the above target pressures equal to or less than a predetermined value, the purge valve open failure diagnosing unit 18 diagnoses the purge valve 7 as being in open failure. When the purge valve 7 is resultantly diagnosed as having the open failure, the flowrate of the hydrogen exhausted by way of the purge valve 7 in the open state is temporarily increased. Therefore, the purge valve open failure diagnosing unit 18 gives instruction to the diluting fan 8 for increasing the diluting capability by increasing taken-in air amount by increasing rotational speed of the diluting fan 8. With this, the exhausted hydrogen can be assuredly diluted to a gas having less than combustible density, thus securing safety. Otherwise, decreasing the fuel cell inlet target pressure Pt-A or stopping the operation of the fuel cell system is allowed.

In addition, for the open failure diagnosis of the purge valve 7, an output (i.e., output Pt2 of the PI controller 32) of the feedback compensator 320 of the hydrogen circulating system inlet target pressure operator 17 can replace the hydrogen circulating system inlet target pressure.

As described above, according to the second embodiment, with the purge valve 7 opened in the ordinary state, the hydrogen circulating system inlet target pressure is increased for keeping the fuel cell inlet pressure at the fuel cell inlet target pressure Pt-A; while with the purge valve 7 closed in the ordinary state, the hydrogen circulating system inlet target pressure is decreased. With the purge valve 7 in the open failure, on the contrary, however, the up-down variation of the hydrogen circulating system inlet target pressure is not caused.

Therefore, the failure diagnosing apparatus of the fuel cell system can assuredly diagnose the open failure of the purge valve 7, based on whether the hydrogen circulating system inlet target pressure causes the up-down variation, specifically, the thus varied amount.

The feedforward compensator 300 of the hydrogen circulating system inlet target pressure operator 17 outputs the constant FF value as the first hydrogen circulating system inlet target pressure Pt1 when the target takeout current It from the fuel cell 1 is less than or equal to a predetermined value, while the purge valve open failure diagnosing unit 18 diagnoses the open failure of the purge valve 7 when the target current It from the fuel cell 1 is less than or equal to the predetermined value. With this, the up-down variation of the hydrogen circulating system inlet target pressure with the purge valve 7 in the open failure can be substantially cancelled by making constant the FF value of the output of the feedforward compensator 300. Therefore, whether the purge valve 7 is in the ordinary state or in the open failure can be distinguished, thus improving diagnosis accuracy.

When the purge valve open failure diagnosing unit 18 diagnoses the purge valve 7 as being in open failure, increasing the diluting capability of the diluting fan 8 allows the diluting fan 8 to sufficiently dilute the hydrogen exhausted from the purge valve 7, thus securing safety. In addition, exhausting the hydrogen after the above sufficient diluting can continue the operation of the fuel cell 1 in open failure of the purge valve 7.

In addition, when the purge valve 7 is diagnosed as having the open failure, decreasing the fuel cell inlet target pressure Pt-A can decrease flowrate of the hydrogen exhausted by way of the purge valve 7, thus improving safety. Otherwise, with the fuel cell system that is unable to continue the operation of the fuel cell 1 when the purge valve 7 is diagnosed as having the open failure, stopping the operation can prevent the hydrogen mix gas (having combustible density) from being exhausted from the purge valve 7, thus securing safety.

### Third Embodiment

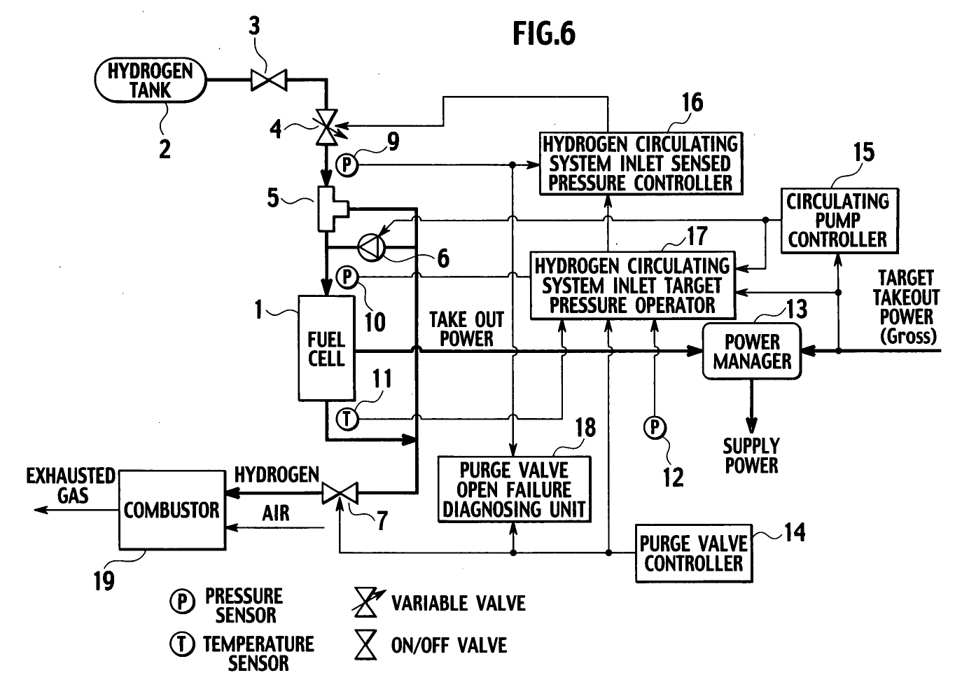

FIG. 6 shows a structure of the failure diagnosing apparatus of the fuel cell system, according to a third embodiment of the present invention. According to the third embodiment in FIG. 6, in place of the hydrogen circulating system inlet target pressure operated by the hydrogen circulating system inlet target pressure operator 17, the purge valve open failure diagnosing unit 18 uses the hydrogen circulating system inlet sensed pressure Ps9 sensed with the second pressure sensor 9, to thereby diagnose the open failure of the purge valve 7. In addition, a combustor 19 in FIG. 6 according to the third embodiment replaces the diluting fan 8 in FIG. 4 according to the third embodiment. Other structural elements according to the third embodiment are substantially like those according to the second embodiment.

Following the hydrogen circulating system inlet target pressure, as is seen in FIG. 5A and FIG. 5B, the hydrogen circulating system inlet sensed pressure Ps9 sensed with the second pressure sensor 9 can be used for the diagnosis, replacing the hydrogen circulating system inlet target pressure.

The combustor 19 combusts the exhausted hydrogen which is purged by way of the purge valve 7. Therefore, when the purge valve 7 is diagnosed as having the open failure, substantially continuously increasing the amount of air supplied to the combustor 19 (including when a closing instruction is given to the purge valve 7) can assuredly combust the exhausted hydrogen and thereafter exhaust the thus exhausted hydrogen, thus securing safety.

In addition, when the purge valve 7 is diagnosed as having the open failure, decreasing the fuel cell inlet target pressure Pt-A or stopping the operation of the fuel cell system is allowed, like the second embodiment.

As described above, the third embodiment can bring about substantially the same effects as those brought about according to the second embodiment. In addition, once the purge valve 7 is diagnosed as having the open failure, the amount of air into the combustor 19 is increased even with an instruction of closing the purge valve 7. With this, the hydrogen-to-air mix ratio in the combustor 19 becomes proper, and the hydrogen from the purge valve 7 is combusted with the combustor 19, thus preventing breakage which may be caused by an excessive temperature of the combustor 19. In addition, continuing the operation of the fuel cell 1 when the purge valve 7 in the open failure is allowed.

### Fourth Embodiment

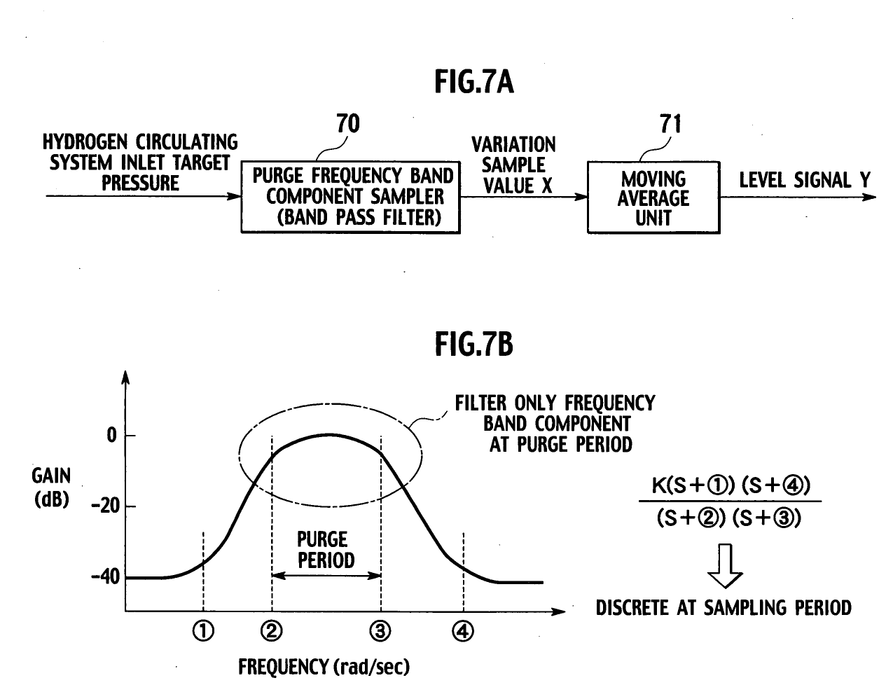

Hereinafter described is a fourth embodiment of the present invention. The fourth embodiment is characterized in that, in addition to the second embodiment in FIG. 4 and the third embodiment in FIG. 6, the control unit is provided with a purge frequency band component sampler 70 and a moving average unit 71 shown in FIG. 7A. Based on a result obtained by the moving average unit 71, the purge valve open failure diagnosing unit 18 diagnoses the open failure of the purge valve 7. Other operations (including control of the hydrogen pressure, and the procedure in the open failure after the diagnosing) according to the fourth embodiment are like those according to the second embodiment and the third embodiment.

In FIG. 7A, the purge frequency band component sampler 70 includes a band pass filter. At a purge period (opening-closing operation frequency) for purging the hydrogen from the fuel cell 1 by way of the purge valve 7, the band pass filter allows passage of only a frequency band component as shown in FIG. 7B. Specifically, the above frequency band component is the one sampled from the hydrogen circulating system inlet target pressure {otherwise, one of the following: i) the hydrogen circulating system inlet sensed pressure Ps9 sensed with the second pressure sensor 9, and ii) output Pt2 of the feedback compensator 320 of the hydrogen circulating system inlet target pressure operator 17 (i.e., output Pt2 of the PI controller 32)}. With the above structure, the purge frequency band component sampler 70 allows passage of the hydrogen circulating system inlet target pressure that is varied by the purging, thereby sampling the purge frequency band component of the hydrogen circulating system inlet target pressure. A variation sample value X is to be given to the moving average unit 71.

The moving average unit 71 makes a moving average of a square of the variation sample value X sampled by the purge frequency band component sampler 70 {otherwise, one of the following: i) the hydrogen circulating system inlet sensed pressure Ps9 sensed with the second pressure sensor 9, and ii) output Pt2 of the feedback compensator 320 of the hydrogen circulating system inlet target pressure operator 17 (i.e., output Pt2 of the PI controller 32)}, to thereby convert the thus obtained into a level signal Y, thereby quantifying the hydrogen circulating system inlet target pressure.

Determining that the level signal Y by the moving average unit 71 is less than or equal to a predetermined value, the purge valve open failure diagnosing unit 18 diagnoses the purge valve 7 as being in open failure.

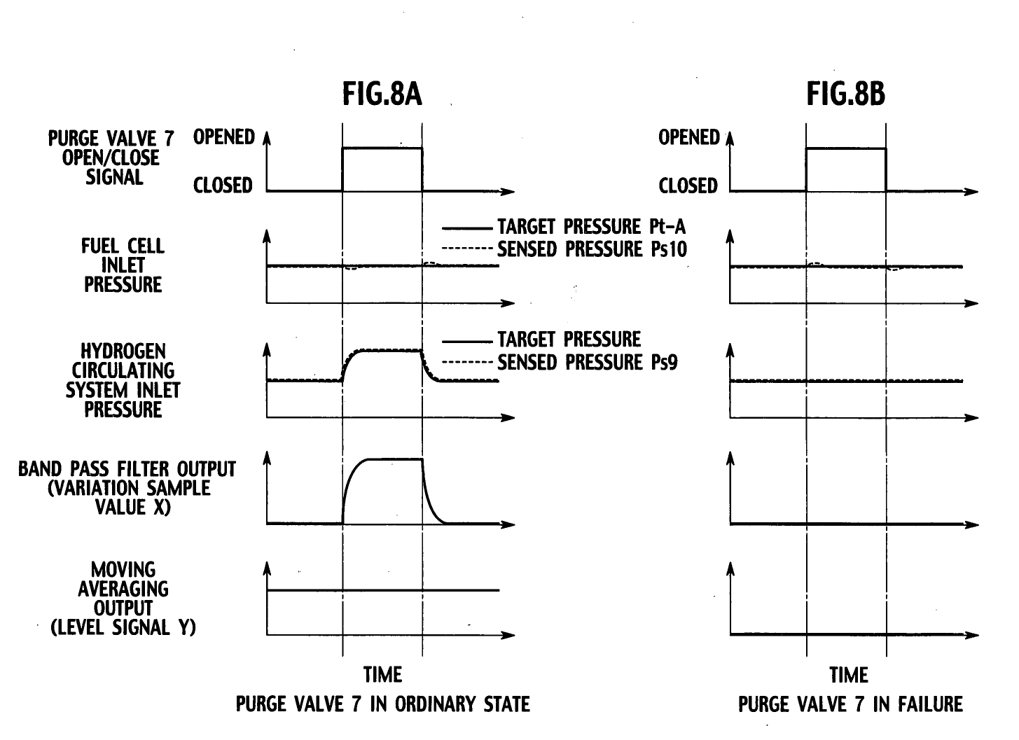

FIG. 8A shows pressure signal response when the purge valve 7 is in the ordinary state, while FIG. 8B shows pressure signal response when the purge valve 7 is in the open-failure. In FIG. 8A, with the purge valve 7 opened in the ordinary state, the hydrogen circulating system inlet pressure is increased for keeping the fuel cell inlet pressure at the fuel cell inlet target pressure Pt-A, while with the purge valve 7 closed in the ordinary state, the hydrogen circulating system inlet pressure is decreased. In addition, the variation sample value X sampled by the purge frequency band component sampler 70, as shown in FIG. 8A, amplifies variation of the hydrogen circulating system inlet pressure, thereby the level signal Y obtained by the moving average of the square of the variation sample value X becomes the predetermined value (output).

On the contrary, with the purge valve 7 in the open failure, even giving to the purge valve 7 the open signal for opening instruction fails to vary the hydrogen circulating system inlet pressure. With this, as shown in FIG. 8B, the purge frequency band component sampler 70 fails to sample the variation and does not output the level signal Y. Based on the above characteristics of the hydrogen circulating system inlet pressure, the purge valve open failure diagnosing unit 18 diagnoses the purge valve 7 as being in open failure when the level signal Y is less than or equal to the predetermined value.

As described above, the fourth embodiment can bring about substantially the same effects as those according to the second embodiment and the third embodiment. In addition, diagnosing the open failure of the purge valve 7 based on the sampled purge frequency band component of the hydrogen circulating system inlet target pressure can amplify the signal of the frequency band component corresponding to the purge period, improving the diagnosis accuracy of the open failure. In addition, quantifying the square of the variation amount of the sampled purge frequency band component by the moving average can diagnose the open failure with an easy logic.

This application is based on a prior Japanese Patent Application No. P2004-281418 (filed on Sep. 28, 2004 in Japan). The entire contents of the Japanese Patent Application No. P2004-281418 from which priority is claimed are incorporated herein by reference, in order to take some protection against translation error or omitted portions.

Although the present invention has been described above by reference to the four embodiments, the present invention is not limited to the four embodiments. Modifications and variations of the any of the four embodiments will occur to those skilled in the art, in light of the above teachings.

The scope of the present invention is defined with reference to the following claims.

What is claimed is:

1. A fuel cell system, comprising:
1) a fuel gas circulating system, including:
a fuel cell for generating an electric power by a chemical reaction of a fuel gas with an oxidant gas,
the fuel gas circulating system being supplied with the fuel gas having a pressure regulated by way of a pressure regulator valve connected to the fuel gas circulating system, and the fuel gas circulating system returning to the fuel cell's inlet the fuel gas which is unused and exhausted from the fuel cell, to thereby circulate the fuel gas;
2) a first pressure sensor for sensing a fuel cell inlet sensed pressure;
3) a second pressure sensor for sensing a fuel gas circulating system inlet sensed pressure;
4) a fuel gas circulating system inlet target pressure operator for operating a fuel gas circulating system inlet target pressure, based on the following:
i) the fuel cell inlet sensed pressure sensed with the first pressure sensor, and
ii) a fuel cell inlet target pressure; and
5) a fuel gas circulating system inlet pressure controller for controlling the pressure of the fuel gas supplied to the fuel cell, by so regulating the pressure regulator valve that the fuel gas circulating system inlet sensed pressure sensed with the second pressure sensor becomes the fuel gas circulating system inlet target pressure operated by the fuel gas circulating system inlet target pressure operator.

2. The fuel cell system as claimed in claim 1,
wherein
the fuel gas circulating system inlet target pressure operator includes:
1) a feedforward compensator for operating a first fuel gas circulating system inlet target pressure, based on a target takeout current from the fuel cell, and
2) a feedback compensator for operating a second fuel gas circulating system inlet target pressure, based on the following:
the fuel cell inlet sensed pressure sensed with the first pressure sensor, and
the fuel cell inlet target pressure, and
wherein
the fuel gas circulating system inlet target pressure operator operates the fuel gas circulating system inlet target pressure, based on the following:
i) the first fuel gas circulating system inlet target pressure operated by the feedforward compensator, and
ii) the second fuel gas circulating system inlet target pressure operated by the feedback compensator.

3. The fuel cell system as claimed in claim 2, wherein
the feedforward compensator of the fuel gas circulating system inlet target pressure operator operates the first fuel gas circulating system inlet target pressure, based on the following:
i) the target takeout current from the fuel cell, and
ii) an operation state of a circulating member structuring the fuel gas circulating system.

4. The fuel cell system as claimed in claim 2,
wherein
the fuel cell system further comprises a purge valve selectively purging the fuel gas exhausted from the fuel cell, and
wherein
the feedforward compensator of the fuel gas circulating system inlet target pressure operator operates the first fuel gas circulating system inlet target pressure, based on the following:
i) the target takeout current from the fuel cell, and
ii) an opening-closing state of the purge valve.

5. The fuel cell system as claimed in claim 4,
wherein
the fuel cell system further comprises an atmospheric pressure sensor sensing an atmospheric pressure around the fuel cell system, and
wherein
the feedforward compensator of the fuel gas circulating system inlet target pressure operator operates the first fuel gas circulating system inlet target pressure, based on the following:
i) the target takeout current from the fuel cell,
ii) the opening-closing state of the purge valve, and
iii) the atmospheric pressure sensed with the atmospheric pressure sensor.

6. The fuel cell system as claimed in claim 4,
wherein
the fuel cell system further comprises a fuel gas temperature sensor sensing a temperature of the fuel gas exhausted from the fuel cell, and
wherein
the feedforward compensator of the fuel gas circulating system inlet target pressure operator operates the first fuel gas circulating system inlet target pressure, based on the following:
i) the target takeout current from the fuel cell,
ii) the opening-closing state of the purge valve, and
iii) the temperature of the fuel gas sensed with the fuel gas temperature sensor.

7. The fuel cell system as claimed in claim 4,
wherein
the fuel cell system further comprises a coolant temperature sensor sensing a temperature of a coolant removing a heat in the electric power generation of fuel cell, and
wherein
the feedforward compensator of the fuel gas circulating system inlet target pressure operator operates the first fuel gas circulating system inlet target pressure, based on the following:
i) the target takeout current from the fuel cell,
ii) the opening-closing state of the purge valve, and
iii) the temperature of the coolant sensed with the coolant temperature sensor.

8. A method of controlling a pressure of a fuel gas supplied to a fuel cell of a fuel cell system which includes a fuel gas circulating system, including the fuel cell for generating an electric power by a chemical reaction of a fuel gas with an oxidant gas, the fuel gas circulating system being supplied with the fuel gas having the pressure regulated by way of a pressure regulator valve connected to the fuel gas circulating system, and the fuel gas circulating system returning to the fuel cell's inlet the fuel gas which is unused and exhausted from the fuel cell, to thereby circulate the fuel gas, the method comprising:
1) sensing a fuel cell inlet sensed pressure;
2) sensing a fuel gas circulating system inlet sensed pressure;
3) operating a fuel gas circulating system inlet target pressure, based on the following:
i) the fuel cell inlet sensed pressure sensed with the first pressure sensor, and
ii) a fuel cell inlet target pressure; and
4) controlling the pressure of the fuel gas supplied to the fuel cell, by so regulating the pressure regulator valve that the fuel gas circulating system inlet sensed pressure sensed by the sensing of the fuel gas circulating system inlet sensed pressure becomes the fuel gas circulating system inlet target pressure operated by the operating of the fuel gas circulating system inlet target pressure.

9. A fuel cell system, comprising:
1) a fuel gas circulating means, including:
an electric power generating means for generating an electric power by a chemical reaction of a fuel gas with an oxidant gas,
the fuel gas circulating means being supplied with the fuel gas having a pressure regulated by way of a pressure regulating means connected to the fuel gas circulating means, and the fuel gas circulating means returning to the electric power generating mean's inlet the fuel gas which is unused and exhausted from the electric power generating means, to thereby circulate the fuel gas;
2) a first pressure sensing means for sensing a fuel cell inlet sensed pressure;
3) a second pressure sensing means for sensing a fuel gas circulating system inlet sensed pressure;
4) a fuel gas circulating system inlet target pressure operating means for operating a fuel gas circulating system inlet target pressure, based on the following:
i) the fuel cell inlet sensed pressure sensed with the first pressure sensing means, and
ii) a fuel cell inlet target pressure; and
5) a fuel gas circulating system inlet pressure controlling means for controlling the pressure of the fuel gas supplied to the electric power generating means, by so regulating the pressure regulating means that the fuel gas circulating system inlet sensed pressure sensed with the second pressure sensing means becomes the fuel gas circulating system inlet target pressure operated by the fuel gas circulating system inlet target pressure operating means.

10. A failure diagnosing apparatus of the fuel cell system that is claimed in claim 2, comprising:
1) a purge valve selectively purging the fuel gas exhausted from the fuel cell; and
2) a failure diagnosing unit diagnosing an open failure of the purge valve based on a variation amount of the second fuel gas circulating system inlet target pressure operated by the feedback compensator of the fuel gas circulating system inlet target pressure operator.

11. The failure diagnosing apparatus as claimed in claim 10, wherein
the feedforward compensator of the fuel gas circulating system inlet target pressure operator outputs a constant value as the first fuel gas circulating system inlet target pressure when the target takeout current from the fuel cell is less than or equal to a predetermined value, and
the failure diagnosing unit diagnoses the open failure of the purge valve when the target takeout current from the fuel cell is less than or equal to the predetermined value.

12. The failure diagnosing apparatus as claimed in claim 10,
wherein
the failure diagnosing apparatus further comprises a sampler for sampling a signal of a frequency band at an opening-closing operation frequency of the purge valve, the sampling of the signal being from one of the following:
1) the second fuel gas circulating system inlet target pressure operated by the feedback compensator of the fuel gas circulating system inlet target pressure operator, and
2) the fuel gas circulating system inlet sensed pressure sensed with the second pressure sensor, and
wherein
the failure diagnosing unit diagnoses the open failure of the purge valve, based on the signal sampled with the sampler.

13. The failure diagnosing apparatus as claimed in claim 10,
wherein
the failure diagnosing apparatus further comprises:
I) a sampler for sampling a signal of a frequency band component at an opening-closing operation frequency of the purge valve, the sampling of the signal being from one of the following:
1) the second fuel gas circulating system inlet target pressure operated by the feedback compensator of the fuel gas circulating system inlet target pressure operator, and
2) the fuel gas circulating system inlet sensed pressure sensed with the second pressure sensor, and
II) a moving average unit making a quantification by implementing a moving average of a square of one of the following:
1) the second fuel gas circulating system inlet target pressure operated by the feedback compensator of the fuel gas circulating system inlet target pressure operator,
2) the signal sampled with the sampler, and
3) the fuel gas circulating system inlet sensed pressure sensed with the second pressure sensor, and
wherein
the failure diagnosing unit diagnoses the open failure of the purge valve based on a signal quantified by the moving average unit.

14. The failure diagnosing apparatus as claimed in claim 10, wherein
the failure diagnosing apparatus further comprises a diluter for diluting the fuel gas exhausted from the fuel cell by way of the purge valve, and
when the failure diagnosing unit diagnoses the purge valve as having the open failure, the diluter increases a diluting capability for diluting the fuel gas.

15. The failure diagnosing apparatus as claimed in claim 10, wherein
the failure diagnosing apparatus further comprises a combustor for combusting the fuel gas exhausted from the fuel cell by way of the purge valve, and
when the failure diagnosing unit diagnoses the purge valve as having the open failure, an amount of air supplied to the combustor is increased for increasing a combusting capability.

16. The failure diagnosing apparatus as claimed in claim 10, wherein
when the failure diagnosing unit diagnoses the purge valve as having the open failure, the fuel cell inlet target pressure is decreased.

17. The failure diagnosing apparatus as claimed in claim 10, wherein
when the failure diagnosing unit diagnoses the purge valve as having the open failure, the fuel cell system stops operating.

18. A failure diagnosing apparatus of the fuel cell system that is claimed in claim 2, comprising:
1) a purge valve selectively purging the fuel gas exhausted from the fuel cell; and
2) a failure diagnosing unit diagnosing an open failure of the purge valve based on a variation amount of the fuel gas circulating system inlet sensed pressure sensed with the second pressure sensor.

19. The failure diagnosing apparatus as claimed in claim 18,
wherein
the failure diagnosing apparatus further comprises a sampler for sampling a signal of a frequency band at an opening-closing operation frequency of the purge valve, the sampling of the signal being from one of the following:
1) the second fuel gas circulating system inlet target pressure operated by the feedback compensator of the fuel gas circulating system inlet target pressure operator, and
2) the fuel gas circulating system inlet sensed pressure sensed with the second pressure sensor, and
wherein
the failure diagnosing unit diagnoses the open failure of the purge valve, based on the signal sampled with the sampler.

20. The failure diagnosing apparatus as claimed in claim 18,
wherein
the failure diagnosing apparatus further comprises:
I) a sampler for sampling a signal of a frequency band component at an opening-closing operation frequency of the purge valve, the sampling of the signal being from one of the following:
1) the second fuel gas circulating system inlet target pressure operated by the feedback compensator of the fuel gas circulating system inlet target pressure operator, and
2) the fuel gas circulating system inlet sensed pressure sensed with the second pressure sensor, and
II) a moving average unit making a quantification by implementing a moving average of a square of one of the following:
1) the second fuel gas circulating system inlet target pressure operated by the feedback compensator of the fuel gas circulating system inlet target pressure operator,
2) the signal sampled with the sampler, and
3) the fuel gas circulating system inlet sensed pressure sensed with the second pressure sensor, and
wherein
the failure diagnosing unit diagnoses the open failure of the purge valve based on a signal quantified by the moving average unit.

21. The failure diagnosing apparatus as claimed in claim 18, wherein
the failure diagnosing apparatus further comprises a diluter for diluting the fuel gas exhausted from the fuel cell by way of the purge valve, and
when the failure diagnosing unit diagnoses the purge valve as having the open failure, the diluter increases a diluting capability for diluting the fuel gas.

22. The failure diagnosing apparatus as claimed in claim 18, wherein
the failure diagnosing apparatus further comprises a combustor for combusting the fuel gas exhausted from the fuel cell by way of the purge valve, and
when the failure diagnosing unit diagnoses the purge valve as having the open failure, an amount of air supplied to the combustor is increased for increasing a combusting capability.

23. The failure diagnosing apparatus as claimed in claim 18, wherein
when the failure diagnosing unit diagnoses the purge valve as having the open failure, the fuel cell inlet target pressure is decreased.

24. The failure diagnosing apparatus as claimed in claim 18, wherein
when the failure diagnosing unit diagnoses the purge valve as having the open failure, the fuel cell system stops operating.
